(19) United States
(12) Patent Application Publication
(10) Pub. No.: US 2026/0336029 A1
(43) Pub. Date: Oct. 29, 2026

(54) DIRECT LASER WELDING OF THIN FOIL MATERIALS

(71) Applicant: GM Global Technology Operations LLC, Detroit, MI (US)

(72) Inventors: William P. Payne, Macomb, MI (US); Dulal Saha, Clinton Township, MI (US)

(21) Appl. No.: 19/191,459

(22) Filed: Apr. 28, 2025

(51) Int. Cl. B23K 26/21; B23K 26/32

(52) U.S. Cl. CPC B23K 26/21; B23K 26/32

(57) ABSTRACT

Systems, methods, and devices form reverse-spiral welds using via holes to vent trapped gases during the laser welding to thereby mitigate or remove effects of trapped gases on the weld joint or include reverse-spiral welds so formed. For example, a workpiece stack having a first component abutting a second component is laser welded with a reverse-spiral weld formed by clamping the workpiece stack, piercing a via hole that is proximate to the inner end of the spiral, scanning a beam along the weld path, and unclamping the workpiece stack. The via hole extends through at least the first component. The via hole is sized and positioned to convey the trapped gas from the interface between the first component and the second component to an exterior of the workpiece stack as it expands from heating during formation of the reverse-spiral weld.

### INTRODUCTION

The disclosure relates to the field of laser welding and, more specifically, to systems and methods for direct laser-welding thin foil materials.

Batteries, such as prismatic lithium batteries, may have a stacked configuration where each cell includes an anode, a separator, and a cathode between a negative current collector and positive current collector. The cells are stacked in an alternating configuration such that adjacent cells share a single current collector therebetween. Each of the current collectors (also referred to as “foils”) includes a tab extending therefrom, and the position of the tab on the current collector may depend on the polarity of the current collector. For example, when assembled into a prismatic battery, the tabs of the positive current collectors are aligned along a first axis that extends in the direction of the stack while the tabs of the negative current collectors are aligned along a second axis that extends in the direction of the stack. Each set of tabs is then bonded together.

Ultrasonic welding is used to bond the tabs together, and the bonded tabs are then laser welded to a respective terminal. The ultrasonic welding is used to bond the tabs while removing gases that are trapped within the interfaces between layers, and the laser welding is used to form a stringer bead that joins the disparate materials of the tabs and the terminals. Without this removal, expansion of the trapped gases from the heat during the laser welding will affect properties of the weld joint (e.g., weaking the resultant joint and/or inhibiting formation of the joint).

There is a need in the art for reducing complexity of the welding process.

### SUMMARY

It is desirable to reduce complexity of the welding process by removing trapped gas and forming optimized laser weld joints without ultrasonic welding the tabs. Systems, methods, and devices as described herein form reverse-spiral welds using via holes to vent trapped gases during the laser welding to thereby mitigate or remove effects of trapped gases on the weld joint.

Moreover, the systems, methods, and devices as described herein may optimize strength and conductivity of the tab assembly by providing a greater cross-sectional area of joined material.

According to aspects of the present disclosure, a method includes obtaining a workpiece stack, determining a weld path, and forming a reverse-spiral weld. The workpiece stack includes a first component abutting a second component to define an interface therebetween. The interface includes trapped gas therein. The weld path is on a surface of the first component that is opposite to the second component. The weld path defines a reverse spiral having a beginning point at an outer end of the reverse spiral and an ending point at an inner end of the reverse spiral. The reverse-spiral weld is formed by clamping the workpiece stack, piercing a via hole that is proximate to the inner end of the spiral, scanning a beam of the at least one laser along the weld path, and unclamping the workpiece stack. The workpiece stack is clamped in a location proximate to the weld path to thereby inhibit movement of a workpiece-stack portion that is to be fused by the reverse-spiral weld. Piercing the via hole occurs after the clamping and using at least one laser. The via hole extends through at least the first component. The via hole is sized and positioned to convey the trapped gas from the interface between the first component and the second component to an exterior of the workpiece stack as it expands from heating during formation of the reverse-spiral weld. The beam is scanned from the beginning point to the ending point to thereby form the reverse-spiral weld that fuses a thickness of the workpiece stack.

According to further aspects of the present disclosure, the workpiece stack includes a metal-foil stack that includes the first component and the second component therein.

According to further aspects of the present disclosure, the via hole is concentric with the ending point of the reverse spiral.

According to further aspects of the present disclosure, the via hole is proximate to a fusion zone of a penultimate turn of the reverse spiral.

According to further aspects of the present disclosure, the method further includes forming a plurality of reverse-spiral welds by determining a plurality of weld paths on the surface of the first component and repeating, for each of the plurality of weld paths, the forming the reverse-spiral weld. Each weld path is a respective reverse spiral having a beginning point at an outer end of the respective reverse spiral and an ending point at an inner end of the respective reverse spiral. Each of the plurality of reverse-spiral welds contacts each reverse-spiral weld adjacent thereto.

According to further aspects of the present disclosure, the plurality of reverse-spiral welds defines an axis with the ending point of each weld path lying along the axis.

According to further aspects of the present disclosure, the beginning point of each weld path is positioned generally perpendicular to the axis from the ending point of the respective weld path.

According to further aspects of the present disclosure, each of the plurality of reverse-spiral welds overlaps each reverse-spiral weld that is adjacent thereto and the overlap is a 25% overlap on a basis of a diameter of the finished spiral weld.

According to further aspects of the present disclosure, each of the plurality of reverse-spiral welds includes a portion corresponding to the starting point of the respective weld path and wherein the portion does not contact any reverse-spiral weld that is adjacent thereto.

According to aspects of the present disclosure, a method includes obtaining a plurality of battery tabs, determining a weld path, and forming a reverse-spiral weld. The plurality of battery tabs includes a first battery tab abutting a second battery tab to define an interface therebetween. The interface includes trapped gas therein. The weld path is on a surface of the first battery tab that is opposite to the second battery tab. The weld path defines a reverse spiral having a beginning point at an outer end of the reverse spiral and an ending point at an inner end of the reverse spiral. The reverse-spiral weld is formed by clamping the plurality of battery tabs, piercing a via hole that is proximate to the inner end of the spiral, scanning a beam of the at least one laser along the weld path, and unclamping the plurality of battery tabs. The plurality of battery tabs is clamped in a location proximate to the weld path to thereby inhibit movement of a workpiece-stack portion that is to be fused by the reverse-spiral weld. Piercing the via hole occurs after the clamping and using at least one laser. The via hole extends through at least the first battery tab. The via hole is sized and positioned to convey the trapped gas from the interface between the first battery tab and the second battery tab to an exterior of the plurality of battery tabs as it expands from heating during formation of the reverse-spiral weld. The beam is scanned from the beginning point to the ending point to thereby form the reverse-spiral weld that fuses a thickness of the plurality of battery tabs.

According to further aspects of the present disclosure, the via hole is concentric with the ending point of the reverse spiral.

According to further aspects of the present disclosure, the method further includes forming a plurality of reverse-spiral welds by determining a plurality of weld paths on the surface of the first tab and repeating, for each of the plurality of weld paths, the forming the reverse-spiral weld. Each weld path is a respective reverse spiral having a beginning point at an outer end of the respective reverse spiral and an ending point at an inner end of the respective reverse spiral. Each of the plurality of reverse-spiral welds contacts each reverse-spiral weld adjacent thereto.

According to further aspects of the present disclosure, the plurality of reverse-spiral welds defines an axis with the ending point of each weld path lying along the axis.

According to further aspects of the present disclosure, the beginning point of each weld path is positioned generally perpendicular to the axis from the ending point of the respective weld path.

According to further aspects of the present disclosure, each of the plurality of reverse-spiral welds overlaps each reverse-spiral weld that is adjacent thereto and the overlap is a 25% overlap on a basis of a diameter of the finished spiral weld.

According to aspects of the present disclosure, battery tabs are joined together by at least one reverse-spiral weld. The at least one reverse-spiral weld is formed by clamping the plurality of battery tabs, piercing a via hole that is proximate to the inner end of the spiral, scanning a beam of the at least one laser along the weld path, and unclamping the plurality of battery tabs. The plurality of battery tabs is clamped in a location proximate to the weld path to thereby inhibit movement of a workpiece-stack portion that is to be fused by the reverse-spiral weld. Piercing the via hole occurs after the clamping and using at least one laser. The via hole extends through at least the first battery tab. The via hole is sized and positioned to convey the trapped gas from the interface between the first battery tab and the second battery tab to an exterior of the plurality of battery tabs as it expands from heating during formation of the reverse-spiral weld. The beam is scanned from the beginning point to the ending point to thereby form the reverse-spiral weld that fuses a thickness of the plurality of battery tabs.

According to further aspects of the present disclosure, the via hole is concentric with the ending point of the reverse spiral.

According to further aspects of the present disclosure, the at least one reverse-spiral weld is a plurality of reverse-spiral welds, and the plurality of reverse spiral welds are formed by determining a plurality of weld paths on the surface of the first tab and repeating, for each of the plurality of weld paths, the forming the reverse-spiral weld. Each weld path is a respective reverse spiral having a beginning point at an outer end of the respective reverse spiral and an ending point at an inner end of the respective reverse spiral. Each of the plurality of reverse-spiral welds contacts each reverse-spiral weld adjacent thereto.

According to further aspects of the present disclosure, the plurality of reverse-spiral welds defines an axis with the ending point of each weld path lying along the axis and the beginning point of each weld path is positioned generally perpendicular to the axis from the ending point of the respective weld path.

According to further aspects of the present disclosure, each of the plurality of reverse-spiral welds overlaps each reverse-spiral weld that is adjacent thereto and the overlap is a 25% overlap on a basis of a diameter of the finished spiral weld.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 illustrates a schematic reverse-spiral weld, according to aspects of the present disclosure;

FIG. 2A-2E illustrate phases of forming of a reverse-spiral weld at a weld site on a workpiece stack, according to aspects of the present disclosure;

FIG. 3 illustrates a plurality of reverse-spiral welds consecutively formed on a workpiece stack, according to aspects of the present disclosure;

FIG. 4 illustrates a method for forming at least one reverse-spiral weld on a workpiece stack, according to aspects of the present disclosure;

FIG. 5 illustrates a method for forming a reverse-spiral weld, according to aspects of the present disclosure;

FIG. 6A-6E illustrate phases of forming of a reverse-spiral weld at a weld site on a workpiece stack, according to further aspects of the present disclosure; and

FIG. 7A-7E illustrate phases of forming of a reverse-spiral weld at a weld site on a workpiece stack, according to yet further aspects of the present disclosure.

### DETAILED DESCRIPTION

Batteries, such as prismatic lithium batteries, may have a stacked configuration where each cell includes an anode, a separator, and a cathode between a negative current collector and positive current collector. The cells are stacked in an alternating configuration such that adjacent cells share a single current collector therebetween.

Each of the current collectors (also referred to as “foils”) includes a tab extending therefrom, and the position of the tab on the current collector may depend on the polarity of the current collector. For example, when assembled into a prismatic battery, the tabs of the positive current collectors are aligned along a first axis that extends in the direction of the stack while the tabs of the negative current collectors are aligned along a second axis that extends in the direction of the stack.

The tabs may be bonded to terminals (also referred to as “current collectors”). For example, the tabs of the positive current collectors are bonded to a positive terminal to enhance electrical conductivity between the positive terminal and each individual tab, and the tabs of the negative current collectors are bonded to a negative terminal to enhance electrical conductivity between the negative terminal and each individual tab.

As described in greater detail below with reference to the figures, a laser scanning system is used to fuse each respective stack of battery tabs to each other and to the respective terminal in a single process. The laser scanning system includes a laser scanning head (also referred to as a scan head or a laser head) and a control unit.

The laser scanning head is configured to direct a laser beam at a target workpiece. The laser scanning head may be moveable relative to the target workpiece. The laser scanning head may form the laser beam to provide a desired beam spot size at a focal plane corresponding to the target workpiece. The laser scanning head may be further configured to move the laser spot relative to the laser scanning head such that the laser spot follows a desired path on the workpiece while the laser scanning head and the target workpiece remain at fixed positions relative to each other.

The control unit is configured to control and coordinate operation of various components of the laser welding system so that the laser scanning head can perform laser cutting and laser joining operations at different locations on a target workpiece.

Prior to joining, the stacked tabs may be aligned with the terminal piece in an at least partially lapped configuration such that a faying surface of the terminal piece is abutting a faying surface of the stacked tabs. Heat is generated at the weld site by the target workpiece absorbing sufficient energy from the impinging laser beam, as well as conducting that energy through the layers below the upper surface of the workpiece to form a melt pool from the substrate material. As the laser scans forward, the melt pool at that area cools to form a weld joint that fuses the battery tabs to each other as well as to the metallic terminal along the faying surfaces thereof.

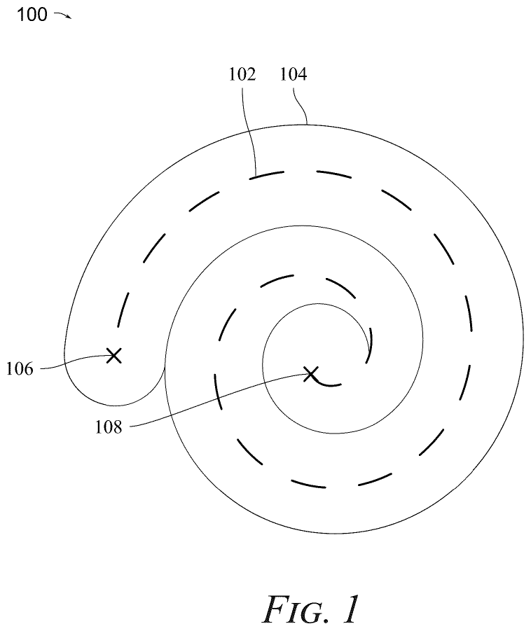

Referring now to FIG. 1, a schematic reverse-spiral weld 100 is shown. The reverse-spiral weld is formed by, for example, the laser system. The illustrated example includes a weld path 102 superimposed over the resultant bead 104. The weld path 102 defines a spiral shape. In some aspects, the spiral shape is an Archimedean spiral. Further, while the illustrated weld path 102 includes two turns, it is contemplated that more turns or fewer turns may be used to achieve a desired weld joint.

To form the reverse-spiral weld 100, a laser beam is scanned along the weld path 102 from the beginning point 106 to the ending point 108. More specifically, the reverse-spiral weld path 102 includes the beginning point 106 at the outer extent of the spiral and the ending point 108 at the interior of the spiral. In some aspects, the ending point 108 is the center of the reverse spiral.

The spiral and the weld bead 104 may be sized such that each turn of the weld is close enough to remelt the inner portion of the fusion zone from the prior turn and provide a contiguous joint.

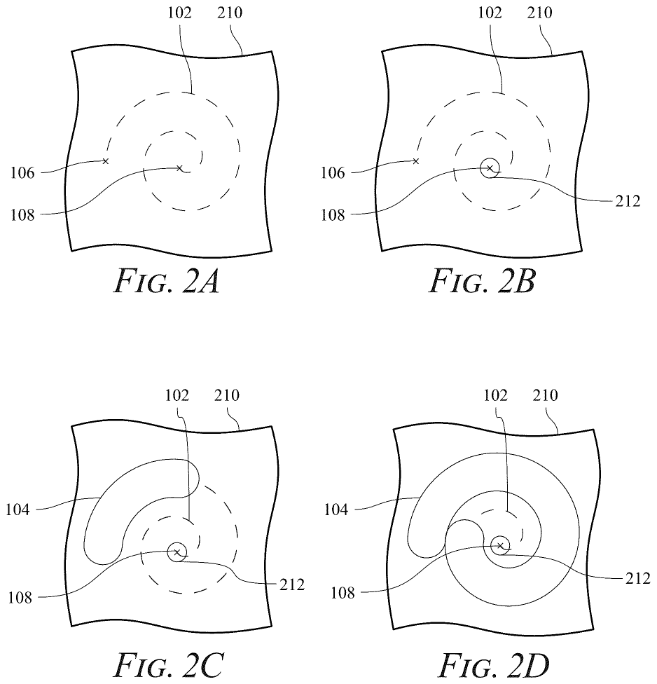

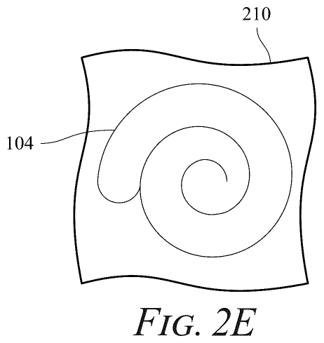

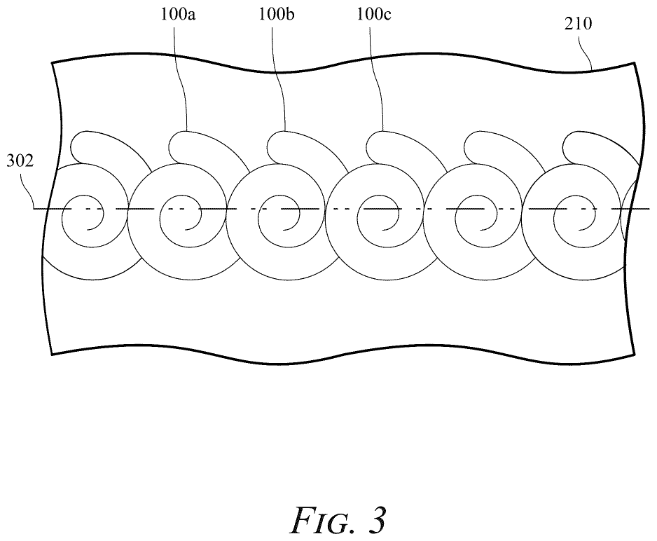

FIG. 2A-2E illustrate formation of a reverse-spiral weld 100 at a weld site on a workpiece stack 210. FIG. 2A illustrates the weld site after planning the weld path 102. After the weld path 102 is planned, the laser moves to the ending point 108 of the weld path 102 to pierce a via hole 212 through the workpiece stack 210.

FIG. 2B illustrates the weld site with the via hole 212 pierced through the workpiece stack 210. In the illustrated example, the via hole 212 is concentric with the ending point 108 of the weld path 102. After the via hole 212 is cut, the laser moves to the starting point 106 of the weld path 102 and begin forming the bead 104.

FIG. 2C illustrates the weld site after the laser has moved along approximately one-quarter of a turn along the reverse-spiral of the weld path 102. During fusion of the layers of the workpiece stack 210, the gases trapped between the faying surfaces and ahead of the melt pool are heated and expand. As the expanding gas builds pressure, portions of it will move short distances along the faying surfaces if the pressure of the expanding gas overcomes the stagnation pressure for a given fluid path. Beneficially, the via hole 212 may provide a predetermined, optimized distance for at least a portion of the expanding gases to escape from the workpiece stack 210 and thereby optimize the porosity of the weld bead 104.

FIG. 2D illustrates the weld site after the laser has moved along approximately one turn of the reverse-spiral of the weld path 102. As the laser approaches forming this portion of the weld bead 104, an amount of trapped gases become circumscribed by the inner perimeter of the fusion zone. At this point in the weld formation, the via hole 212 provides a low-resistance path for movement of the amount of trapped gases as they expand to thereby convey them to the environment instead of absorbing them into the weld joint or ejecting molten material as they escape through the melt pool. Beneficially, the via hole 212 vents all or substantially all of the trapped, circumscribed gas.

FIG. 2E illustrates the reverse-spiral weld bead 104 at the weld site after the laser has completed its scan of the weld path 102.

Beneficially, venting the trapped, circumscribed gas through the via hole 212 optimizes porosity of the weld bead 104, retained material of the workpiece stack 210 in the weld joint, and/or uniformity of properties through the reverse-spiral weld 100 joint. The optimized porosity of the weld bead 104 occurs because the trapped air is vented in a controlled fashion rather than being absorbed into the melt pool. The optimized material retention occurs by preventing rapid depressurization of trapped gas pockets into the melt pool at a velocity that carries some molten material out of the melt pool. The optimized uniformity of the weld joint includes optimized mechanical and/or electrical properties. Optimized mechanical properties include, for example, more uniform conditions for the outer perimeter of the fusion zone during formation and the ending point 108 of the weld bead 104 being within that outer perimeter. Optimized electrical properties include, for example, reduced porosity and uniform crystal structure throughout the reverse-spiral weld 100.

FIG. 3 illustrates a plurality of reverse-spiral welds 100a-c with each being consecutively formed on a workpiece stack 210. The individual weld beads 104, such as a first reverse-spiral welds 100a, may be formed in a manner similar to that described with reference to FIG. 2A-2E, above.

The plurality of reverse-spiral welds 100 defines an axis 302. In the illustrated example, the ending point 108 of each weld path 102 lies along the axis 302. It is contemplated that the ending point 108 of each weld path 102 may be offset from the axis 302 in a predetermined pattern, such as an alternating pattern. For example, a first of the reverse-spiral welds 100a-c may be offset from the axis 302 by a predetermined distance in a first direction and an adjacent second of the reverse-spiral welds 100a-c may be offset from the axis 302 by the predetermined distance in a second direction that is opposite to the first direction.

Beneficially, the plurality of reverse-spiral welds 100a-c may at least contact adjacent ones of the plurality of reverse-spiral welds 100a-c to enhance uniformity and continuity of a cross-section of the weld joint along the axis 302. In the illustrated example, each of the plurality of reverse-spiral welds 100a-c overlaps any adjacent reverse-spiral welds 100a-c. While not being bound by theory, it is believed that overlapping the reverse-spiral welds 100a-c provides for further optimized porosity of the weld bead 104 by venting trapped gases from the faying surfaces that were heated and pressurized during formation of the prior reverse-spiral weld 100.

In some aspects, the overlap is a 25% overlap measured on a basis of the diameter of the finished spiral weld. Beneficially, while not being bound by theory, it is believed that the 25% overlap optimizes a cross-sectional area of the weld joint along the axis 302 to thereby optimize electrical properties through the weld joint.

In some aspects, the beginning point 106 of each weld path 102 is positioned generally perpendicular to the axis 302 from the ending point 108 of the respective weld path 102. Beneficially, while not being bound by theory, it is believed that this optimizes uniformity of the properties of the weld joint along the axis 302 because the portions of the weld bead 104 that are formed under the dynamic substrate conditions associated with weld bead 104 starting conditions are outside of the continuous portions of the joint. Moreover, this positioning also optimizes uniformity of the edge of the fusion zone of the weld joint that is opposite to the starting point 106.

Beneficially, the plurality of reverse-spiral welds 100a-c may be placed on the workpiece stack 210 such that the beginning points 106 experience fewer mechanical stresses than the opposite edge of the plurality of reverse-spiral welds 100a-c during later operation of the workpiece stack 210 (such as from heating and cooling of the workpiece stack 210 during operation or environmental changes).

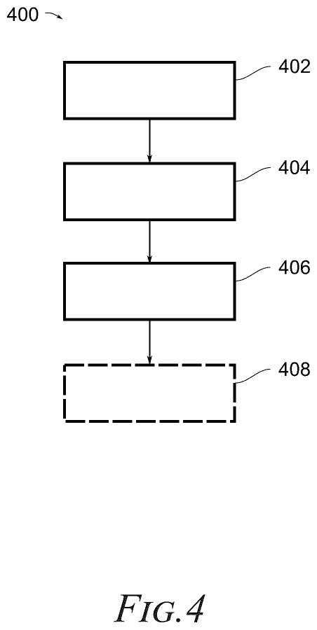

FIG. 4 illustrates a method 400 for forming at least one reverse-spiral weld. At block 402, a workpiece stack 210 is obtained. The workpiece stack 210 includes a first component and a second component. In some aspects, the workpiece stack 210 is a stack of electrode foils and the components are individual ones of the foils. For example, the first component may be the uppermost electrode foil and the second component may be the electrode foil that is adjacent to the uppermost electrode foil. The first component abuts the second component to define an interface therebetween. During stacking of the components, small volumes of gas are trapped in the interface.

At block 404, a weld path 102 is determined. The weld path 102 may be, for example, on the surface of the first component that is opposite to the second component. The weld path 102 is selected such that the resulting weld joint will extend through the workpiece stack 210 to thereby fuse the workpiece stack 210. The weld path 102 defines a reverse spiral such that the starting point 106 of the weld path 102 is at an outer end of the reverse spiral and the ending point 108 of the weld path 102 is at an inner end of the reverse spiral.

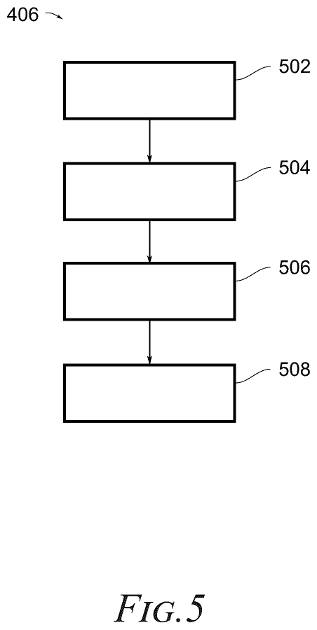

At block 406, a reverse-spiral weld is formed by, for example, the method described with reference to FIG. 5, below.

Optionally, at block 408, a plurality of reverse-spiral welds may be formed by determining additional weld paths in a method similar to block 404 and repeating, for each of the plurality of reverse-spiral welds, the forming of block 406. In some aspects, each reverse-spiral weld 100 of the plurality of reverse-spiral welds is in contact with each of the reverse-spiral welds 100 that is adjacent thereto. For example, if the plurality of reverse-spiral welds is arranged in a line, then each reverse-spiral weld at the end of the line will contact only one adjacent reverse-spiral weld and each reverse-spiral weld at the ends of the line will contact two adjacent reverse-spiral welds. In some aspects, the reverse-spiral welds are laid down consecutively.

FIG. 5 illustrates an example of forming 406 the reverse-spiral weld on the workpiece stack 210. At block 502, the workpiece stack 210 is clamped. The clamping is configured to prevent movement of the portion of the components of the workpiece stack 210 that are to be fused during the welding process. The clamping is also configured to maintain the workpiece stack 210 at a known position relative to the head of the laser. In some aspects, the clamp is applied proximate to the weld site. Beneficially, applying the clamp proximate to the weld site helps to increase interfacial contact between the layers of the workpiece stack 210.

At block 504, a via hole 212 is cut. The via hole 212 is cut after the clamping and using the laser. The via hole 212 is configured to convey gas that is trapped within the interfaces between the layers of the workpiece stack 210 to the exterior of the workpiece stack 210 to thereby inhibit porosity of the weld bead 104 from the trapped gas entering the melt pool. The via hole 212 is sized and positioned such that all or substantially all of the gas that is trapped during formation of the reverse-spiral weld (e.g., gas bounded by the first turn of the reverse-spiral weld). The via hole 212 is proximate to the inner end of the spiral.

In some aspects, the via hole 212 is concentric with the end of the spiral. Additionally, or alternatively, the via hole 212 may be proximate to the fusion zone of the penultimate turn of the reverse spiral (e.g., the edge of the via hole 212 is close to the penultimate turn but maintains structural integrity such that the melt pool of the penultimate turn does not breach the via hole). For example, the via hole 212 may be concentric with the end of the spiral and sized such that the edge of the via hole 212 is proximate to the fusion zone of the penultimate turn of the reverse spiral (e.g., the via hole 212 is approximately the size of the bead). In further examples, the via hole 212 may be smaller than the size of the weld bead 104 and offset from the end of the spiral such that the edge of the via is proximate to the fusion zone of the penultimate turn of the reverse-spiral weld. Beneficially, this optimizes the amount of substrate material that forms the resultant weld while still evacuating the trapped gases. For example, the via hole 212 may be offset from the end of the spiral by being placed beyond the end of the weld path 102. Additionally, or alternatively, the via hole 212 may be offset from the end of the spiral by being positioned at the final extent of the melt pool.

At block 506, the laser beam is scanned along the weld path 102 from the starting point 106 to the ending point 108 to thereby form the reverse-spiral weld. The laser beam is provided at a predetermined power and a predetermined scan speed to fuse the layers of the workpiece stack 210. Moreover, the predetermined scan speed is selected such that the trapped gases are evacuated through the via hole 212 instead of infiltrating the melt pool.

At block 508, the workpiece stack 210 is unclamped such that the workpiece stack 210 may be moved relative to the laser head. For example, the workpiece stack 210 may be transferred to downstream processes or may be reclamped in another position for additional welding.

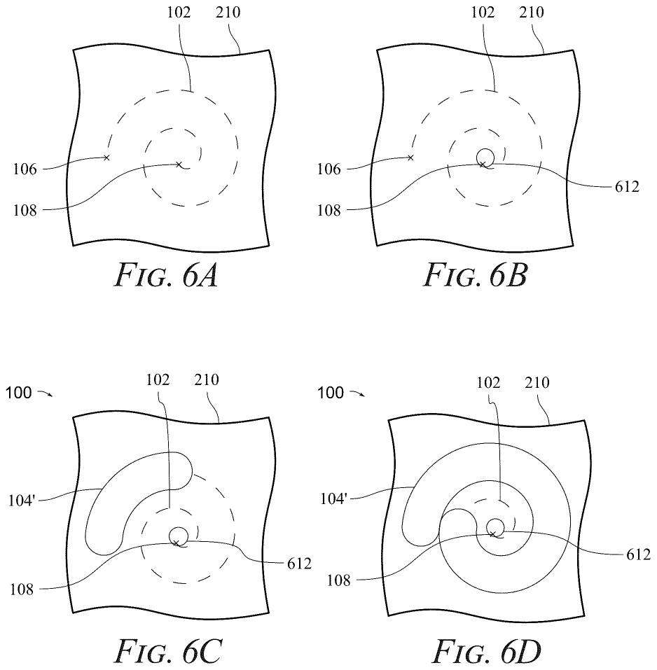

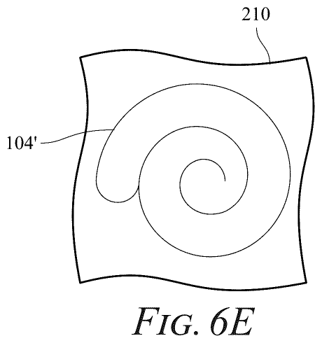

FIG. 6A-6E illustrate formation of a reverse-spiral weld 100 at a weld site on a workpiece stack 210. FIG. 6A illustrates the weld site after planning the weld path 102. After the weld path 102 is planned, the laser moves to the ending point 108 of the weld path 102 to pierce a via hole 612 through the workpiece stack 210.

FIG. 6B illustrates the weld site with the via hole 612 pierced through the workpiece stack 210. In the illustrated example, the via hole 612 is centered beyond the ending point 108 of the weld path 102 and proximate to the fusion zone of the penultimate turn of the reverse-spiral weld 100. Beneficially, while not being bound by theory, it is believed that centering the via hole 612 beyond the ending point 108 of the weld path 102 optimizes evacuation of trapped gases throughout the full weld bead 104′. After the via hole 612 is cut, the laser moves to the starting point 106 of the weld path 102 and begins forming the weld bead 104′.

FIG. 6C illustrates the weld site after the laser has moved along approximately one-quarter of a turn along the reverse-spiral of the weld path 102. During fusion of the layers of the workpiece stack 210, the gases trapped between the faying surfaces and ahead of the melt pool are heated and expand. As the expanding gas builds pressure, portions of it will move short distances along the faying surfaces if the pressure of the expanding gas overcomes the stagnation pressure for a given fluid path. Beneficially, the via hole 612 may provide a predetermined, optimized distance for at least a portion of the expanding gases to escape from the workpiece stack 210 and thereby optimize the porosity of the weld bead 104′.

FIG. 6D illustrates the weld site after the laser has moved along approximately one turn of the reverse-spiral of the weld path 102. As the laser approaches forming this portion of the weld bead 104′, an amount of trapped gases become circumscribed by the inner perimeter of the fusion zone. At this point in the weld formation, the via hole 612 provides a low-resistance path for movement of the amount of trapped gases as they expand to thereby convey them to the environment instead of absorbing them into the weld joint or ejecting molten material as they escape through the melt pool. Beneficially, the via hole 612 vents all or substantially all of the trapped, circumscribed gas.

FIG. 6E illustrates the reverse-spiral weld bead 104′ at the weld site after the laser has completed its scan of the weld path 102. Beneficially, venting the trapped, circumscribed gas through the via hole 212 optimizes porosity of the weld bead 104′, retained material of the workpiece stack 210 in the weld joint, and/or uniformity of properties through the reverse-spiral weld 100 joint. The optimized porosity of the weld bead 104′ occurs because the trapped air is vented in a controlled fashion rather than being absorbed into the melt pool. The optimized material retention occurs by preventing rapid depressurization of trapped gas pockets into the melt pool at a velocity that carries some molten material out of the melt pool. The optimized uniformity of the weld joint includes optimized mechanical and/or electrical properties. Optimized mechanical properties include, for example, more uniform conditions for the outer perimeter of the fusion zone during formation and the ending point 108 of the weld bead 104′ being within that outer perimeter. Optimized electrical properties include, for example, reduced porosity and uniform crystal structure throughout the reverse-spiral weld 100.

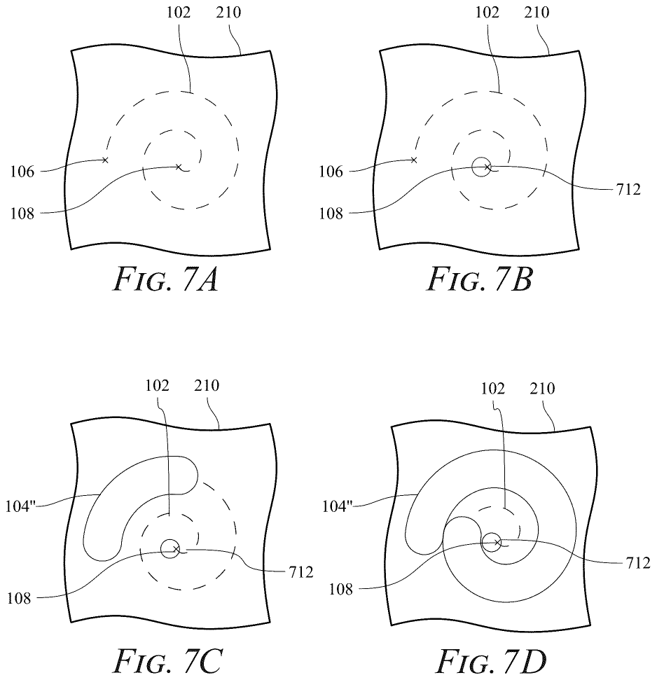

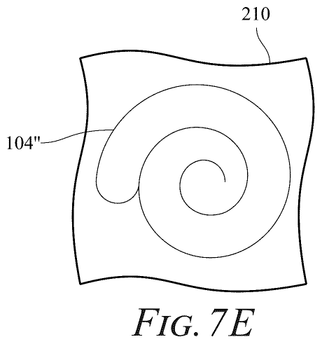

FIG. 7A-7E illustrate formation of a reverse-spiral weld 100 at a weld site on a workpiece stack 210. FIG. 7A illustrates the weld site after planning the weld path 102. After the weld path 102 is planned, the laser moves to the ending point 108 of the weld path 102 to pierce a via hole 712 through the workpiece stack 210.

FIG. 7B illustrates the weld site with the via hole 712 pierced through the workpiece stack 210. In the illustrated example, the via hole 712 is centered immediately prior to the ending point 108 of the weld path 102 and proximate to the fusion zone of the penultimate turn of the reverse-spiral weld 100. Beneficially, while not being bound by theory, it is believed that placing the via hole 712 immediately prior to the ending point 108 of the weld path 102 optimizes flow properties of the melt pool at the end of the weld bead 104″. After the via hole 712 is cut, the laser moves to the starting point 106 of the weld path 102 and begins forming the weld bead 104″.

FIG. 7C illustrates the weld site after the laser has moved along approximately one-quarter of a turn along the reverse-spiral of the weld path 102. During fusion of the layers of the workpiece stack 210, the gases trapped between the faying surfaces and ahead of the melt pool are heated and expand. As the expanding gas builds pressure, portions of it will move short distances along the faying surfaces if the pressure of the expanding gas overcomes the stagnation pressure for a given fluid path. Beneficially, the via hole 712 may provide a predetermined, optimized distance for at least a portion of the expanding gases to escape from the workpiece stack 210 and thereby optimize the porosity of the weld bead 104″.

FIG. 7D illustrates the weld site after the laser has moved along approximately one turn of the reverse-spiral of the weld path 102. As the laser approaches forming this portion of the weld bead 104″, an amount of trapped gases become circumscribed by the inner perimeter of the fusion zone. At this point in the weld formation, the via hole 712 provides a low-resistance path for movement of the amount of trapped gases as they expand to thereby convey them to the environment instead of absorbing them into the weld joint or ejecting molten material as they escape through the melt pool. Beneficially, the via hole 712 vents all or substantially all of the trapped, circumscribed gas.

FIG. 7E illustrates the reverse-spiral weld bead 104″ at the weld site after the laser has completed its scan of the weld path 102. Beneficially, venting the trapped, circumscribed gas through the via hole 212 optimizes porosity of the weld bead 104″, retained material of the workpiece stack 210 in the weld joint, and/or uniformity of properties through the reverse-spiral weld 100 joint. The optimized porosity of the weld bead 104″ occurs because the trapped air is vented in a controlled fashion rather than being absorbed into the melt pool. The optimized material retention occurs by preventing rapid depressurization of trapped gas pockets into the melt pool at a velocity that carries some molten material out of the melt pool. The optimized uniformity of the weld joint includes optimized mechanical and/or electrical properties. Optimized mechanical properties include, for example, more uniform conditions for the outer perimeter of the fusion zone during formation and the ending point 108 of the weld bead 104″ being within that outer perimeter. Optimized electrical properties include, for example, reduced porosity and uniform crystal structure throughout the reverse-spiral weld 100.

While the above aspects are described using a single scanning head, it is contemplated that multiple lasers may be used in the piercing and/or the welding of the workpiece stack 210.

As used in the present disclosure, the term “spiral” may refer to a reverse-spiral weld pattern as context dictates. For example, a spiral weld and a reverse-spiral weld may trace the same path, but the spiral weld would begin the weld bead at the interior of the spiral while the reverse-spiral weld would begin the weld bead at the exterior of the spiral.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover all modifications, equivalents, combinations, sub-combinations, permutations, groupings, and alternatives falling within the scope and spirit of the disclosure and as defined by the appended claims.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “substantially” are readily understood by one of ordinary skill in the art, the term “substantially” indicates that the stated numerical value or property allows some imprecision. If the imprecision provided by “substantially” is not otherwise understood in the art with this ordinary meaning, then “substantially” indicates at least variations that may arise from manufacturing processes and measurement of such parameters. For example, if not otherwise understood in the art, the term “substantially” means within 5% (e.g., ±5%) of the stated value.

While the metes and bounds of the term “essentially” are readily understood by one of ordinary skill in the art, the term “essentially” indicates that the stated numerical value or property allows some slight imprecision. If the imprecision provided by “essentially” is not otherwise understood in the art with this ordinary meaning, then “essentially” indicates at least negligible variations in desired parameters that may be impracticable to overcome. For example, if not otherwise understood in the art, the term “essentially” means within 1% (e.g., ±1%) of the stated value.

While the metes and bounds of the term “pure” are readily understood by one of ordinary skill in the art, the term “pure” indicates that the compound may include very slight traces of other materials. If the imprecision provided by “pure” is not otherwise understood in the art with this ordinary meaning, then “pure” indicates at least variations that may arise from separation processes and measurement of such parameters. For example, if not otherwise understood in the art, the term “pure” means above 99.9% of the stated material.

It is to be understood that the ranges provided herein include the stated range, subranges within the stated range, and each value within the stated range. For example, a range from 5% to 20% should be interpreted to include not only the explicitly recited limits of about 5% to about 20%, but also to include individual values, such as 5%, 7%, 9%, 13%, etc., and sub-ranges, such as from about 5% to about 9%, about 7% to about 10%, etc.

While the best modes for carrying out the disclosure have been described in detail, those familiar with the art to which this disclosure relates will recognize various alternative designs and embodiments for practicing the disclosure within the scope of the appended claims.

What is claimed is:

1. A method comprising:
obtaining a workpiece stack including a first component abutting a second component to define an interface therebetween, the interface including trapped gas therein;
determining a weld path on a surface of the first component that is opposite to the second component, the weld path defining a reverse spiral having a starting point at an outer end of the reverse spiral and an ending point at an inner end of the reverse spiral; and
forming a reverse-spiral weld by:
clamping the workpiece stack in a location proximate to the weld path to thereby inhibit movement of a workpiece-stack portion that is to be fused by the reverse-spiral weld;
piercing, after the clamping and using at least one laser, a via hole that is proximate to the inner end of the spiral, the via hole extending through at least the first component and being sized and positioned to convey the trapped gas from the interface between the first component and the second component to an exterior of the workpiece stack as it expands from heating during formation of the reverse-spiral weld;
scanning a beam of the at least one laser along the weld path from the starting point to the ending point to thereby form the reverse-spiral weld that fuses a thickness of the workpiece stack; and
unclamping the workpiece stack.

2. The method of claim 1, wherein the workpiece stack includes a metal-foil stack that includes the first component and the second component therein.

3. The method of claim 1, wherein the via hole is concentric with the ending point of the reverse spiral.

4. The method of claim 1, wherein the via hole is proximate to a fusion zone of a penultimate turn of the reverse spiral.

5. The method of claim 1, further comprising forming a plurality of reverse-spiral welds by:
determining a plurality of weld paths on the surface of the first component, wherein each weld path is a respective reverse spiral having a starting point at an outer end of the respective reverse spiral and an ending point at an inner end of the respective reverse spiral; and
repeating, for each of the plurality of weld paths, the forming the reverse-spiral weld,
wherein each of the plurality of reverse-spiral welds contacts each reverse-spiral weld adjacent thereto.

6. The method of claim 5, wherein the plurality of reverse-spiral welds defines an axis with the ending point of each weld path lying along the axis.

7. The method of claim 6, wherein the starting point of each weld path is positioned generally perpendicular to the axis from the ending point of the respective weld path.

8. The method of claim 5, wherein each of the plurality of reverse-spiral welds overlaps each reverse-spiral weld that is adjacent thereto and the overlap is a 25% overlap on a basis of a diameter of the finished spiral weld.

9. The method of claim 5, wherein each of the plurality of reverse-spiral welds includes a portion corresponding to the starting point of the respective weld path and wherein the portion does not contact any reverse-spiral weld that is adjacent thereto.

10. A method comprising:
obtaining a plurality of battery tabs including a first tab abutting a second tab to define an interface therebetween, the interface including trapped gas therein;
determining a weld path on a surface of the first tab that is opposite to the second tab, the weld path defining a reverse spiral having a starting point at an outer end of the reverse spiral and an ending point at an inner end of the reverse spiral; and
forming a reverse-spiral weld by:
clamping the plurality of battery tabs in a location proximate to the weld path to thereby inhibit movement of a workpiece-stack portion that is to be fused by the reverse-spiral weld;
piercing, after the clamping and using at least one laser, a via hole that is proximate to the inner end of the spiral, the via hole extending through at least the first tab and being sized and positioned to convey the trapped gas from the interface between the first tab and the second tab to an exterior of the plurality of battery tabs as it expands from heating during formation of the reverse-spiral weld;
scanning a beam of the at least one laser along the weld path from the starting point to the ending point to thereby form the reverse-spiral weld that fuses a thickness of the plurality of battery tabs; and
unclamping the plurality of battery tabs.

11. The method of claim 10, wherein the via hole is concentric with the ending point of the reverse spiral.

12. The method of claim 10, further comprising forming a plurality of reverse-spiral welds by:
determining a plurality of weld paths on the surface of the first tab, wherein each weld path is a respective reverse spiral having a starting point at an outer end of the respective reverse spiral and an ending point at an inner end of the respective reverse spiral; and
repeating, for each of the plurality of weld paths, the forming the reverse-spiral weld,
wherein each of the plurality of reverse-spiral welds contacts each reverse-spiral weld adjacent thereto.

13. The method of claim 12, wherein the plurality of reverse-spiral welds defines an axis with the ending point of each weld path lying along the axis.

14. The method of claim 13, wherein the starting point of each weld path is positioned generally perpendicular to the axis from the ending point of the respective weld path.

15. The method of claim 12, wherein each of the plurality of reverse-spiral welds overlaps each reverse-spiral weld that is adjacent thereto and the overlap is a 25% overlap on a basis of a diameter of the finished spiral weld.

16. A plurality of battery tabs joined together by at least one reverse-spiral weld, the at least one reverse-spiral weld being formed by:
clamping the plurality of battery tabs in a location proximate to the weld path to thereby inhibit movement of the plurality of battery tabs at a portion that is to be fused by the reverse-spiral weld;
piercing, after the clamping and using at least one laser, a via hole that is proximate to the inner end of the spiral, the via hole extending through at least the plurality of battery tabs and being sized and positioned to convey trapped gas from faying interfaces between layers of the plurality of battery tabs to an exterior of the plurality of battery tabs as the trapped gas expands from heating during formation of the reverse-spiral weld;
scanning a beam of the at least one laser along the weld path from the starting point to the ending point to thereby form the reverse-spiral weld that fuses a thickness of the plurality of battery tabs; and
unclamping the plurality of battery tabs.

17. The plurality of battery tabs of claim 16, wherein the via hole is concentric with the ending point of the reverse spiral.

18. The plurality of battery tabs of claim 16, wherein the at least one reverse-spiral weld is a plurality of reverse-spiral welds, and the plurality of reverse spiral welds are formed by:
determining a plurality of weld paths on the surface of the first tab, wherein each weld path is a respective reverse spiral having a starting point at an outer end of the respective reverse spiral and an ending point at an inner end of the respective reverse spiral; and
repeating, for each of the plurality of weld paths, the forming the reverse-spiral weld,
wherein each of the plurality of reverse-spiral welds contacts each reverse-spiral weld adjacent thereto.

19. The plurality of battery tabs of claim 18, wherein the plurality of reverse-spiral welds defines an axis with the ending point of each weld path lying along the axis and the starting point of each weld path is positioned generally perpendicular to the axis from the ending point of the respective weld path.

20. The plurality of battery tabs of claim 18, wherein each of the plurality of reverse-spiral welds overlaps each reverse-spiral weld that is adjacent thereto and the overlap is a 25% overlap on a basis of a diameter of the finished spiral weld.
